(19) United States
(12) Patent Application Publication
(10) Pub. No.: US 2007/0079305 A1
(43) Pub. Date: Apr. 5, 2007

(54) Alignment of variable length program instructions within a data processing apparatus

(75) Inventor: Dirk Duerinckx, Wilsele (BE)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/523,668

(22) Filed: Sep. 20, 2006

(30) Foreign Application Priority Data
Oct. 3, 2005 (GB) 0520064.7

(51) Int. Cl. G06F 9/45

(52) U.S. Cl. 717/151

(57) ABSTRACT

A compiler is provided for compiling program instructions in dependence upon a predetermined decoder input instruction alignment. The compiler comprises a program instruction sequence generator operable to process source code to produce a sequence comprising a plurality of program instructions for input to a decoder. At least one program instruction is reordered within a storage region of program memory. The storage region has an associated memory address and an offset value. The offset value gives a starting location of said program instruction within the memory address. The reordering of the program instruction is such that manipulations of instruction units of the plurality of program instructions required to achieve the predetermined decoder input instruction alignment are less complex than manipulations that would be required if no reordering had been performed. According to a further aspect, a program instruction aligner is provided to shift at least one portion of the reordered (reformatted) program instruction to produce the predetermined decoder-input instruction alignment. The offset value and an instruction length are supplied as control inputs to the program instruction aligner. A plurality of connections between register fields and shifter fields of the program instruction aligner is such that at least one of said plurality of register fields is connected to only a subset of said plurality of shifter fields.

### BACKGROUND OF THE INVENTION

1. Field of the Invention

The present invention relates to the field of data processing. More particularly, this invention relates to data processing systems that support execution of variable length program instructions and compilers for variable length program instructions.

2. Description of the Prior Art

An example of a category of data processors that support execution of variable length program instructions are very long instruction word (VLIW) processors, which provide highly parallel execution of data processing operations. Such systems have a plurality of data path elements and are operable independently to perform in parallel respective data processing operations specified by a VLIW program instruction.

In these data processing systems a compiler is operable to generate a sequence of at least one program instruction. The program instruction sequence is stored in program memory and prior to execution, each program instruction is read out into an instruction register and then supplied to a decoder, which generates control signals to control data processing circuitry to perform data processing operations specified by the program instructions. Typically, the program instruction will be supplied to the decoder according to a predetermined format. Alignment of the program instructions is performed using a program instruction aligner, which shifts the program instruction, in dependence upon an offset value, such that it is appropriately aligned for input to the decoder. If many different instruction lengths are supported, then the program instruction aligner used to align the variable length instructions can become large and complex. For example, a program instruction aligner suitable for handling instruction lengths in the range of one to eight program instruction units of 32 bits typically requires 5000 gates, which can amount to around 10% of the gate-count of the data processing unit.

If the program instructions can vary in length from 1 to N units, then a “full cross-bar” program instruction aligner will typically require N*N multiplexer inputs (i.e. N multiplexers, each having N inputs) to rotate N program instruction units over an offset of O, where O is in the range 1 to N. A logarithmic shifter implementation of a program instruction aligner can be used as an alternative to full cross-bars to achieve a reduction in complexity from N*N to N*Log2(N). However, there is a requirement to further reduce the complexity of program instruction aligners to more efficiently support execution of variable length program instructions.

### SUMMARY OF THE INVENTION

According to a first aspect, the present invention provides a compiler for compiling program instructions in dependence upon a predetermined decoder input instruction alignment, said compiler comprising: a program instruction sequence generator operable to process source code to produce a sequence comprising a plurality of program instructions for input to a decoder, at least one of said plurality of program instructions having an instruction length of at least two instruction units and wherein said at least one program instruction has a respective storage region within said program memory, said storage region having an associated memory address and an offset value, said offset value giving a starting location of said program instruction within said memory address; and a program instruction reformatter operable to reorder said at least two instruction units of said at least one program instruction within said storage region to generate a reordered program instruction, said reordering being such that manipulations of instruction units of said plurality of program instructions required to achieve said predetermined decoder input instruction alignment are less complex than manipulations that would be required if no reordering had been performed.

The present invention recognizes that the instruction unit ordering according to which a program instruction is stored in program memory may differ considerably from a predetermined decoder input instruction alignment, which means that complex program instruction aligner circuitry is required in order to shift the instruction units into an appropriate alignment for input to the decoder after they have been read out from program memory. A reordering of instruction units of at least one program instruction of a plurality of program instructions to be input to a decoder is performed. The reordering is performed within the storage region allocated to that instruction in program memory. In this way the at least one instruction unit can be more appropriately positioned for input to the decoder. The reordering is such that manipulations of instruction units of the plurality of program instructions required to achieve the predetermined decoder input instruction alignment are less complex than manipulations that would be required if no reordering had been performed. This reduces the size and complexity of the program instruction alignment circuitry and reduces its power consumption.

It will be appreciated that to reduce the complexity of the alignments to be performed on the compiled program instructions, the reordering performed on a given program instruction by the compiler need not necessarily align an instruction unit such that its position corresponds to its respective final position in the predetermined decoder input instruction alignment. Indeed, the overall number and nature of the alignments required to be performed to place a group of program instructions output by the compiler into the predetermined decoder input instruction alignment can still be reduced if the instruction unit is not output by the compiler in a position corresponding to its required final position in the predetermined decoder input instruction alignment. Rather, the group properties of reordered program instructions (e.g. of all possible instruction unit orderings and offsets for different instruction widths and for a given aligner width) can be arranged so as to reduce the complexity of an aligner required to align the compiled program instructions prior to input in the required format to the decoder. The reduction in complexity can be, for example, so as to reduce the number of multiplexer inputs between register fields of a register holding an instruction as output by the compiler and register fields of a register that holds the corresponding program instruction in the predetermined decoder input instruction alignment prior to input to the decoder. However, in one embodiment, the reordering of the at least two instruction units of the at least one program instruction is such that at least one of the instruction units is in a position corresponding to its respective position in the predetermined decoder input instruction alignment.

In one embodiment the program memory comprises at least two memory banks and each of the at least two instruction units is stored in a respective one of the at least two memory banks. In one embodiment each of the at least two memory banks has an associated memory bank data width and a data width of each of the at least two instruction units is equal to the memory bank data width. This provides a simpler control structure since each instruction unit can be readily associated with a respective memory bank.

In one embodiment the instruction unit ordering of the reformatted instruction by the program instruction reformatter is such that each instruction unit of the reformatted program instruction that can be placed in a position corresponding to its predetermined position in the predetermined decoder input alignment given the storage region is placed in the predetermined position. Thus, where possible, given the storage region in program memory within which the program instruction can be reordered, an ordering as close as possible to the predetermined decoder input alignment is achieved. This provides an overall reduction in the number of shifts of instruction units of the reformatted program instruction that must be performed relative to a program instruction that has not been reordered by the compiler.

In one embodiment, if an instruction unit of the reformatted program instruction cannot be placed in the predetermined position given the memory space, the program instruction reformatter is operable to place the instruction unit in a position that reduces a total number of alternative positions of that instruction unit in a plurality of reformatted program instructions. Thus, despite not having the flexibility to align the program units to match the alignment of the respective program unit in the predetermined decoder input instruction alignment, the complexity of shifting circuitry that will be used to fully align the reformatted program instruction is reduced by restricting the number of alternative positions that can be occupied by a given instruction unit within a group of reformatted program instructions having, for example, different offsets or different instruction lengths.

In one embodiment the program instruction reformatter is operable to reformat a plurality of program instructions to produce a respective plurality of reformatted program instructions. In one particular embodiment of this type the plurality of program instructions comprises program instructions having variable instruction lengths. Instructions having different instructions lengths will occupy different sizes of storage regions in the program memory and are likely to have to be reordered in different ways to produce the predetermined decoder input instruction alignment. The program instruction reformatter can efficiently take account of these varying reordering requirements and reduce the complexity of shifting circuitry required to align the reordered instructions to the predetermined decoder input alignment relative to the circuitry that would be required for program instructions that have not been reordered by the compiler.

In one embodiment the predetermined decoder-input instruction alignment is a big-endian instruction alignment and in an alternative embodiment is a little-endian instruction alignment.

According to a second aspect, the present invention provides a method of compiling program instructions in dependence upon a predetermined decoder input instruction alignment, said method comprising the steps of: processing source code to produce a sequence comprising a plurality of program instructions for input to a decoder, at least one of said plurality of program instructions having an instruction length of at least two instruction units and wherein said at least one program instruction has a respective storage region within said program memory, said storage region having an associated memory address and an offset value, said offset value giving a starting location of said program instruction within said memory address; and reordering said at least two instruction units of said at least one program instruction within said storage region to generate a reordered program instruction, said reordering being such that manipulations of instruction units of said plurality of program instructions required to achieve said predetermined decoder input instruction alignment are less complex than manipulations that would be required if no reordering had been performed.

According to a third aspect, the present invention provides a program instruction aligner operable to read the reformatted program instruction from a program memory and to shift at least one portion of said reformatted program instruction generated by a compiler according to claim 1 in order to align said reformatted program instruction in accordance with a predetermined decoder-input instruction alignment for input to an instruction decoder, said program instruction aligner comprising: an instruction register having a plurality of register fields, said instruction register being operable to store said reformatted program instruction; a control input operable to receive said instruction length and said offset value associated with said reformatted program instruction; and a shifter having: a plurality of shifter fields, a number of said plurality of shifter fields being operable to receive said at least two instruction units of said reformatted program instruction from said plurality of register fields; and an array of multiplexers operable to provide a plurality of connections between at least some of said plurality of register fields and at least some of said plurality of shifter fields; wherein said shifter is operable to shift in dependence upon said instruction length and said offset value, at least a portion of said reformatted program instruction to produce said predetermined decoder-input instruction alignment and wherein said plurality of connections is such that at least one of said plurality of register fields is connected to only a subset of said plurality of shifter fields, said reformatted instruction having an instruction unit ordering such that no connections from the at least one register field to ones of the plurality of shifter fields outside said subset are required to produce said predetermined decoder-input instruction alignment.

The present invention recognizes that by using the compiler to reorder the program instructions, the program instruction alignment circuitry can be reduced in complexity since the instruction unit ordering of the reformatted program instruction can be arranged such that full connectivity of register fields of the instruction register to shifter fields of the shifter of the program aligner is not required. Rather, at least one of the register fields is connected to only a subset of the shifter fields. The requirement for connections to shifter fields not belonging to the subset is eliminated by appropriately reordering the instructions at the compilation stage. This results in an overall reduction in the multiplexer inputs, which leads to program instruction alignment circuitry that has a reduced circuit area and reduced power consumption.

In one embodiment, the shifter is operable to shift each of a plurality of reformatted program instructions corresponding to a respective plurality of instruction unit orderings and the subset is dependent upon the plurality of instruction unit orderings. Thus the instruction unit orderings can be suitably selected so as to reduce the number of shifter fields belonging to the subset, which in turn reduces the number of multiplexer inputs that must be provided from the plurality of shifter fields to that register field and reduces the complexity and circuit area associated with the shifter.

In one embodiment, the plurality of instruction unit orderings is such that the shifter is operable to produce the predetermined decoder-input instruction alignment by shifting in a single direction between one end of the plurality of shifter fields and an opposite end of the plurality of shifter fields. This means that in the reordered program instructions a reordered position of the instruction unit will always be to the left of the predetermined position of that instruction unit in the predetermined program instruction alignment for little-endian decoder input alignments for each of the plurality of reordered program instructions. By way of contrast, for big-endian decoder input alignments the reordered position of the instruction unit will be to the right of the predetermined position of that instruction unit in the predetermined program instruction alignment. This simplifies the control circuitry of the shifter and reduces the overall number of shifts performed by the shifter to achieve the predetermined decoder input alignment. Note that this also differs from an arrangement that simply shifts each instruction unit by a number of positions associated with the offset to achieve the predetermined decoder input instruction alignment.

In one embodiment, the instruction unit ordering of the reformatted program instruction is such that at least one of the instruction units is in a position corresponding to its respective position in the predetermined decoder-input instruction alignment. Thus for the at least one instruction unit no shifting need be performed by the shifter.

In one embodiment, the instruction unit ordering of the reformatted instruction is such that each instruction unit of the reformatted program instruction that can be placed in a position corresponding to its predetermined position in the predetermined decoder input alignment is placed in the predetermined position.

In one embodiment, the plurality of instruction unit orderings are restricted such that the subset is a minimal subset that enables the predetermined decoder-input alignment to be obtained for each of the plurality of reformatted program instructions.

In one embodiment if a given instruction unit of the reformatted program instruction cannot be placed in the predetermined position by the program instruction reformatter, it is placed in a position that reduces a total number of alternative positions of the given instruction unit in the plurality of reformatted program instructions thereby reducing the subset.

In one embodiment, a data width of at least one of the plurality of shifter fields is equal to a data width of a corresponding one of the plurality of register fields. In one particular embodiment, the plurality of shifter fields are equal in number to the plurality of register fields. These embodiments simplify the connectivity of the array of multiplexers.

In one embodiment the reformatted program instruction comprises an instruction-length specifying portion and wherein the instruction length specifying portion is used to derive the instruction length for supplying to the control input.

In one embodiment, the program instruction aligner comprises an instruction length extraction register operable to store a copy of the reformatted program instruction and to extract the instruction length from the instructions length specifying portion to supply to the control input. This provides an efficient way of conveying the correct instruction length to the control input for a given instruction. In one embodiment, the length-specifying portion corresponds to a flag bit in each of the at least two instruction units. This provides for straightforward extraction of the instruction length from the program instruction.

In one embodiment, the shifter is operable to receive a portion of the reformatted program instruction that excludes the instruction-length specifying portion. Thus information from the instruction-length specifying portion can be separated and processed in parallel with the shifter performing alignment of the re-ordered program instruction. The portion of the reformatted instruction that is excluded from the shifter input, can be used to determine the instruction length and can also be passed on to the decoder for use during the decoding process.

In one embodiment, the shifter of the program instruction aligner is a full cross-bar shifter having at least one input removed. In one alternative embodiment, the shifter is implemented as a logarithmic shifter comprising a plurality of two-input multiplexers and having at least one fewer two-input multiplexer than a standard logarithmic shifter. In some of these logarithmic shifter embodiments there is at least one duplicated multiplexer relative to the standard logarithmic shifter.

The reordering of the program instructions by the compiler prior to supplying them to the program instruction aligner reduces the functional complexity of the shifter by reducing the total number of multiplexer inputs in the shifter for both the full cross-bar arrangement and for the modified logarithmic shifter type arrangements according to the present technique.

According to a fourth aspect of the present invention there is provided a computer program product holding a computer readable medium including computer readable instructions that when executed perform the steps of a method according to a second aspect of the present invention.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates the architecture of a configurable VLIW data engine;

FIG. 2 schematically illustrates a VLIW processor;

FIG. 3A schematically illustrates a generic form of a program instruction associated with the VLIW processor of FIG. 2;

FIGS. 3B to 3G schematically illustrate alternative code formats of VLIW program instructions;

FIG. 4 schematically illustrates the structure of the program memory of FIG. 2 comprising a plurality of memory banks;

FIG. 5A schematically illustrates a decoding flow involving a program instruction aligner configured to receive encoded program instructions that have not been re-ordered by a compiler;

FIG. 5B schematically illustrates a decoding flow involving a program instruction aligner configured to receive encoded program instructions that have been re-ordered by the a compiler according to the present technique;

FIG. 6A is a table listing positions of program instruction units as they are input to fields of a two-unit program instruction aligner (i.e. as output by the compiler), for a compiler that implements a standard ordering in program memory;

FIG. 6B is a table of program instruction units positions corresponding to the table of FIG. 6A but for a compiler that implements program instruction re-ordering according to the present technique;

FIG. 7A is a table listing positions of program instruction units as they are input to fields of a four-unit program instruction aligner (i.e. as output by the compiler), for a compiler that implements a standard ordering in program memory;

FIG. 7B is a table of program instruction units positions corresponding to the table of FIG. 7A but for a compiler that implements program instruction re-ordering according to the present technique;

FIGS. 8A and 8B schematically illustrates instruction unit ordering at three different stages of the decoding sequence for one of the examples in the tables of FIGS. 6A and 6B;

FIG. 9A is a table listing positions of program instruction units as they are input to fields of a eight-unit program instruction aligner (i.e. as output by the compiler), for a compiler that implements a standard ordering in program memory;

FIG. 9B is a table of program instruction units positions corresponding to the table of FIG. 9A but for a compiler that implements a first program instruction re-ordering according to the present technique;

FIG. 9C is a table of program instruction units positions corresponding to the table of FIG. 9A but for a compiler that implements a second program instruction re-ordering according to the present technique;

FIG. 9D schematically illustrates a program instruction aligner corresponding to the tables of FIG. 9A;

FIG. 9E schematically illustrates a program instruction aligner according to the present technique and corresponding to the tables of FIG. 9A and FIG. 9B;

FIG. 9F schematically illustrates an alternative arrangement for a program instruction aligner 1010 corresponding to the tables of FIG. 9A, which aligns program instructions that have not been reordered;

FIG. 9G schematically illustrates a modified logarithmic shifter implementation of a program instruction aligner arranged to align the reordered program instructions-of the tables of FIG. 9;

FIG. 10 is program code used to generate the instruction re-ordering of FIG. 9C;

FIG. 11 is a series of tables showing select signals and multiplexer inputs required for the program instruction aligner configured to receive program instructions that have been re-ordered as listed in FIG. 9C; and

FIG. 12 schematically illustrates a program instruction aligner arrangement comprising a combination of two different program instruction aligners that is operable to align program instructions for input to a decoder.

### DESCRIPTION OF THE PREFERRED EMBODIMENTS

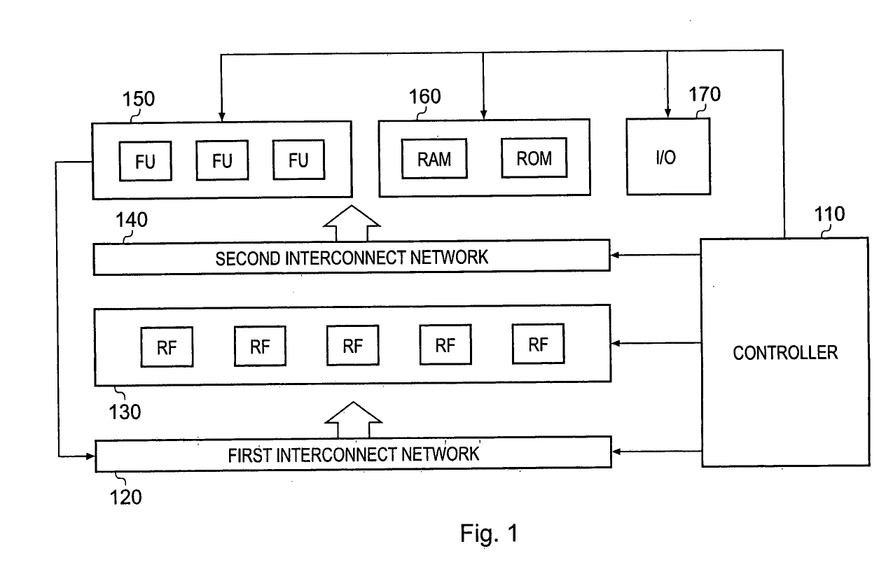

FIG. 1 schematically illustrates the architecture of a configurable VLIW data engine. The arrangement comprises: a controller 110; a first interconnect network 120; a series of register files 130; a second interconnect network 140; an array of functional units 150; a series of memories 160 and input/output (IO) circuitry 170.

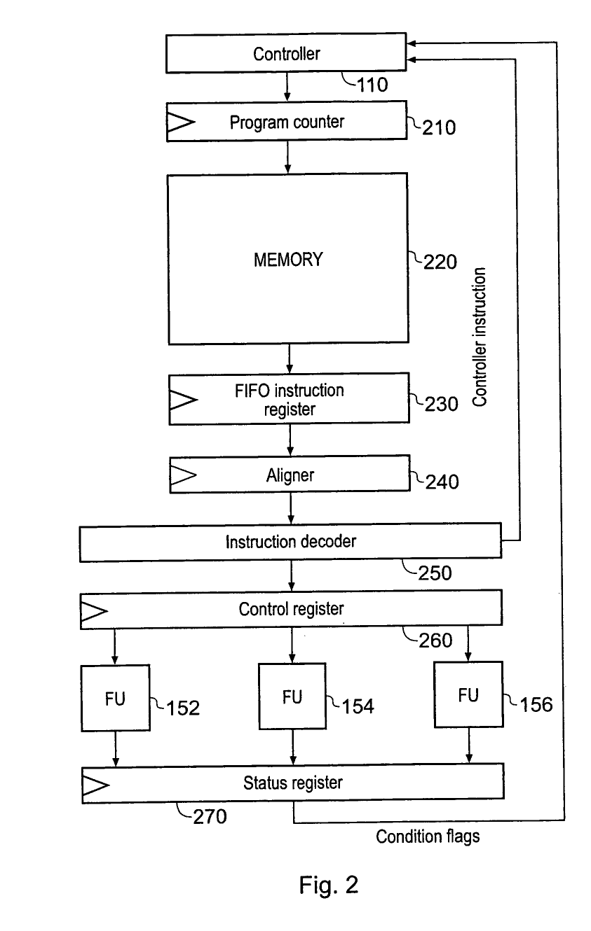

The controller 110 receives control instructions from an instruction decoder (see FIG. 2). The decoded instruction directly drives control signals which are sent to the first and second interconnect networks 120, 140, the series of register files 130, the array of functional units 150, the series of memories 160 and the I/O circuitry 170.

The first and second interconnect networks 120, 140 each comprise arrays of wires and multiplexers, which are configurable by the controller 110 to provide data communication paths. The first interconnect network 120 receives result data from the array of functional units 150 and routes this result data to the series of register files 130 for storage. The second interconnect network 140 supplies data read from the series of register files 130 to the array of functional units 150 as input for processing operations and to the series of memories 160 for storage. The series of memories 160 comprises random access memory (RAM) and read only memory (ROM). The array of functional units 150 comprises arithmetic logic units (ALUs), multiplexers, adders, shifters, floating point units and other functional units. Data is read from register files 130 and routed in-parallel through the array of functional units 150 where computations are performed in dependence upon control signals from the controller 110. The results of those computations are then routed back to the register files 130 for storage via the first interconnect network 120. The controller 110 configures the functional units 150, the register files 130 and the interconnect networks 120, 140 to perform a desired data processing operation or parallel set of operations in a given processor clock cycle.

In the arrangement of FIG. 1, the second interconnect network 140 is hardwired. However in alternative arrangements, the second interconnect network 140 is configurable by the controller 110.

FIG. 2 schematically illustrates a VLIW processor according to the present technique. The arrangement comprises: the controller 110; a program counter 210; an program memory 220; a first in first out (FIFO) instruction register 230; a program instruction aligner 240; and instruction decoder 250; a control register 260; a series of three functional units 152, 154, 156; and a status register 270.

The controller 110 executes controller instructions and sends control signals that control data processing operations. The program counter 210 keeps track of the instruction currently being fetched from program memory. Since there is a delay in the FIFO instruction register 230 and the control register 260, the fetched instruction will be executed a couple of cycles later (how much later depends on the structure of the FIFO instruction register 230).

The program counter 210 also provides an index to a program instruction stored at a memory address within the program memory 220.

The program counter 210 keeps track of the instruction currently being FETCHED from program memory, not executed. Because there is delay in the FIFO instruction register and the control register, that instruction will be executed a couple of cycles later (how much later depends on the structure of the FIFO instruction register).

The program memory 220 stores variable length program instruction words. Instructions from the program memory 220 are output as fixed-length memory access words to the FIFO instruction register 230. Individual instructions from the FIFO instruction register are supplied to the program instruction aligner, which aligns each instruction so that it is in an appropriate format to input to the instruction decoder 250. In order to perform the rotation, the program instruction aligner is provided with an instruction offset and an instruction length associated with a given program instruction. In this example embodiment the instructions are aligned such that the least significant bit (LSB) of the-instruction is at bit position 0 of the decoder input. It will be appreciated that in alternative embodiments the alignment could be different, for example, the instruction could alternatively be aligned such that the most significant bit is at bit 0 of the decoder input. The instruction decoder 250 decodes the program instructions to produce control signals for performing data processing operations. In this VLIW processor, all of the functional units 152, 154, 156 are controlled in parallel via a control bus (not shown) in the second interconnect array 140. Since the width of the control bus is equal to the width of the VLIW instruction word, this yields a very wide instruction word. Parts of a program application that have a large degree of parallelism will exploit this wide instruction word more efficiently.

The VLIW processor of FIG. 2 is operable to execute a plurality of different instruction sets such that different instruction sets can be used for different processing tasks according, for example, to the degree of parallelism required. The instruction decoder 250 serves to expand each instruction word of any given instruction set to the width of the control bus before that instruction word is applied to the data path. The decoded VLIW instructions are stored in the control register 260. Control signals from the control register 260 are supplied to particular ones of the array of functional units 150 of FIG. 1. For simplicity, a subset of three functional units 152, 154, 156 are shown in FIG. 2. These functional units 152, 154, 156 are responsive to the control signals from the control register 260 to perform data processing operations on operands read from the register files 130 and supplied to the functional units 152, 154, 156 via the second interconnect network 140 (see FIG. 1). Results of the data processing operations are stored in the status register 270 and are subsequently fed back to the register files 130 via the first interconnect network 110. The controller 110 is responsive to condition flags resulting from recently executed program instructions and supplied to the controller 110 via the status register 270. The controller 110 is also responsive to decoded controller instructions that it receives from the instruction decoder 250. The controller 110 controls the program counter 210 to increment sequentially through program instructions stored in the program memory 220.

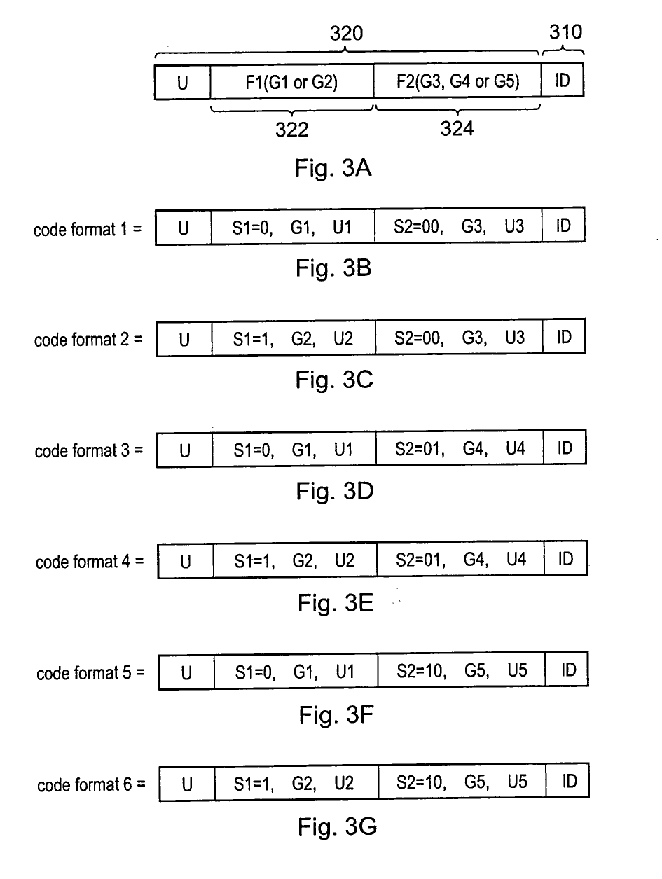

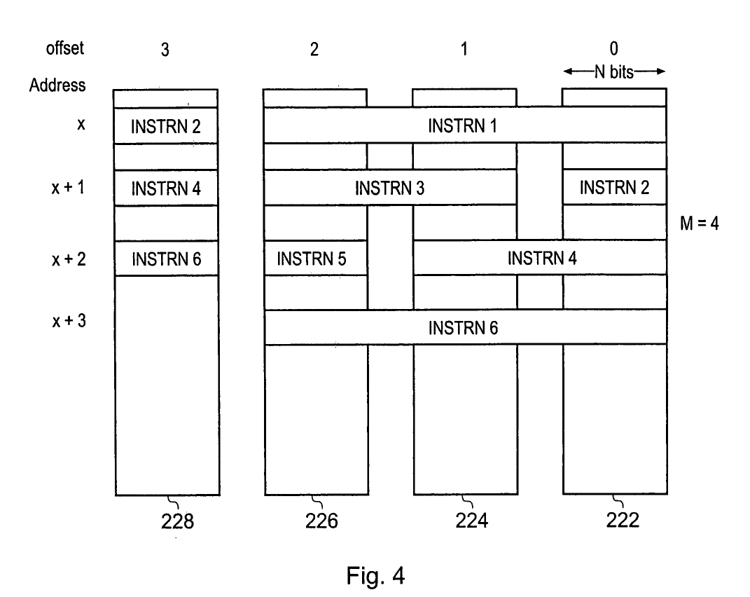

FIG. 3A schematically illustrates a generic form of a program instruction associated with the VLIW processor of FIG. 2. The program instruction comprises an instruction set identifier field 310 and an instruction field portion 320. In this case the instruction comprises two instruction fields 322 and 324. The instruction fields 320 contain the actual encoded instruction bits which include bits specifying control of the controller 110 and a plurality of instruction fields relating to particular ones of the functional units 152, 154, 156, specifying operations to be performed by those functional units. The program memory 220 is subdivided into a plurality M of memory banks (see FIG. 4), each memory bank being N bits wide. The program instruction is accessible in N-bit blocks (denoted program instruction units) such that M blocks of N-bits are accessible in parallel by the FIFO instruction register 230. Accordingly, the maximum width of a program instruction is constrained to be M*N bits.

FIGS. 3B to 3G schematically illustrate six different code formats that can be associated with the two-field instruction of FIG. 3A. To describe as many decoded VLIW instructions as possible using a single encoded program instruction, the instruction fields 322, 324 are defined hierarchically in terms of (i) control groups and (ii) operation sets. An operation set consists of a list of commands for a particular command bus on a specific resource (e.g. a specific functional unit 152, 154, 156). A control group comprises a list of these operation sets. Each control group consists of a collection of operation sets for command buses that are always controlled simultaneously. For example the command bus associated with a read port from a register file dedicated to an ALU input will be assigned to the same control group as the command buses of that ALU since the ALU will likely always require data from that register file. In the examples of FIGS. 3B to 3G, the first instruction field F1 contains two control groups, G1 and G2, where as the second instruction field contains three control groups, G3, G4 and G5. S1 and S2 are the group selector bits. U and U1 . . . U5 are unused microcode memory bank and instruction field bits respectively.

FIG. 4 schematically illustrates the structure of the program memory 220 of FIG. 2 comprising a plurality of memory banks. To store variable length encoded instructions, the program memory is subdivided into a plurality M of memory banks each having a width of N bits. In this embodiment, M=4 so the program memory 220 comprises a first memory bank 222, a second memory bank 224, a third memory bank 226 and a fourth memory bank 228. The program memory 220 has two control parameters: the number of banks and the bank width. The memory bank width is equal to the width of a program instruction unit. Values from all four memory banks 222, 224, 226, 228 can be read in parallel. An offset value from the set {0, 1, 2, 3} is associated with each program instruction. The offset value, a memory address and an instruction length are required to specify the memory region occupied by a given program instruction. In the example embodiment of FIG. 4, six variable length program instructions are currently stored in the program memory 220. The least significant bit of each program instruction word is stored in the right-most memory bank spanned by that program instruction. For example, program instruction 3 spans the second memory bank 224 and the third memory bank 226 and the least significant bit is in the right-most bit position of the second memory bank 224. Each program instruction is completely defined by a memory address (or program counter value), the offset of the first word of the instruction and the instruction length. Instruction 1 has address X, offset 0 and comprises three instruction units; instruction 2 has address X, offset 3 and comprises two instruction units; instruction 3 has address X+1, offset 1 and comprises two instruction units; instruction 4 has address X+1, offset 3 and comprises three instruction units; instruction 5 has address X+2, offset 2 and comprises one instruction unit; and instruction 6 has address X+2 offset 3 and comprises four instruction units. Note that the six instructions are stored in the program memory 220 in concatenated form so that bits associated with two or more program instructions may be associated with a given memory address, e.g. at address X+1 bits associated with instructions 2, 3 and 4 are all stored.

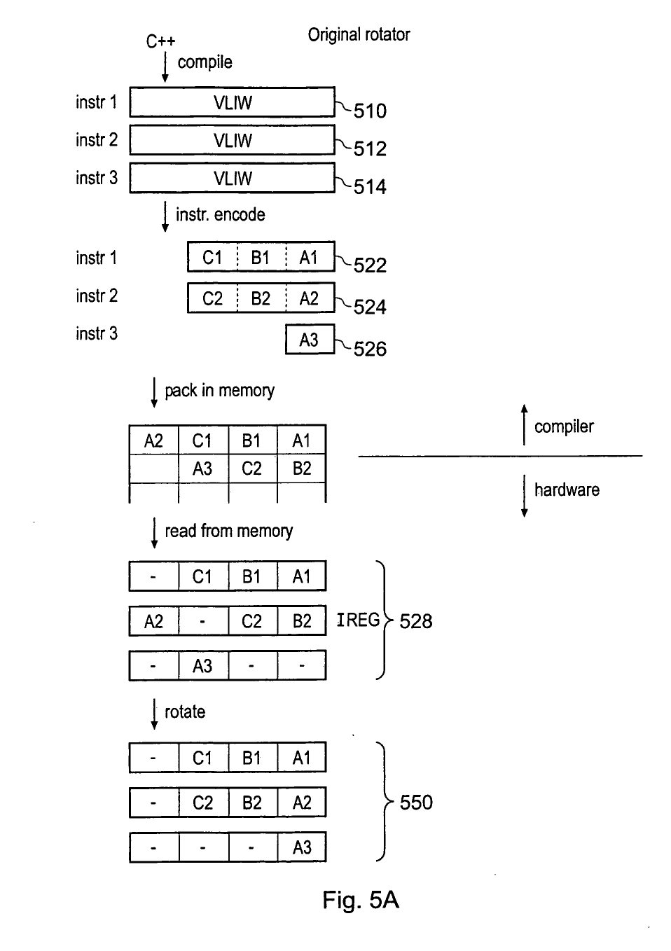

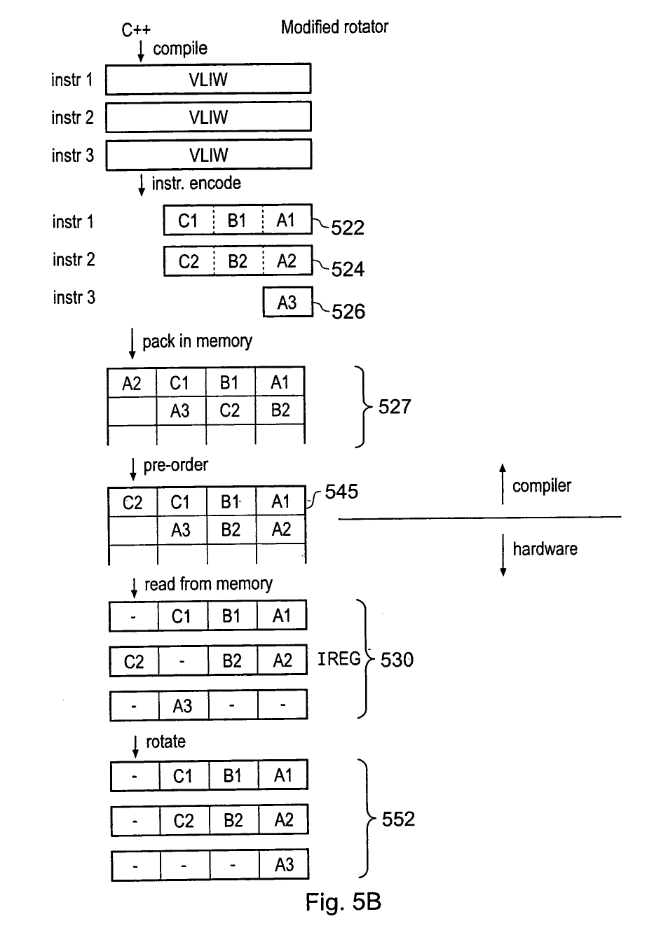

FIG. 5A schematically illustrates a decoding flow involving a program instruction aligner operable to align program instructions generated by a compiler that stores instructions in program memory according to a standard ordering. The program instruction aligner of this arrangement corresponds to the “rotator” as described in co-pending GB patent application number 0410986.4 entitled “Program Instruction Compression”. The process begins with a first VLIW instruction word 510, a second VLIW instruction word 512 and a third VLIW instruction word 514. Each of these VLIW instruction words comprises four N-bit instruction units. These three instruction words are encoded so as to generate a first encoded instruction 522, a second encoded instruction 524 and a third encoded instruction 526 respectively. Note that the encoded program instructions are more compact than the VLIW instructions 510, 512, 514. In particular, whereas the unencoded VLIW instructions each- comprise four instruction units whereas the first and second encoded instructions comprise three N-bit instruction units and the third encoded instruction 526 comprises a single N-bit instruction unit. The first encoded instruction 522 comprises a least significant N-bit instruction unit A1, a next most significant N-bit instruction unit B1 and a most significant N-bit instruction unit C1. The second encoded instruction 524 comprises a least-significant N-bit instruction unit A2, a next most significant N-bit instruction unit B2 and a most significant N-bit instruction unit C2. The third encoded instruction 526 comprises a single N-bit instruction unit A3. The compiler packs the encoded program instructions into the program memory 220 at stage 530 according to the standard ordering as shown. The encoded program instructions are concatenated in the program memory 220, which comprises four N-bit memory banks. Encoded instruction units A1, B1 and C1 of the first encoded instruction 522 are stored respectively at offsets 0, 1 and 2 at address X; instruction unit A2 of the second instruction is stored at address X and offset 3 whereas the remaining instruction units B2 and C2 of the second instruction are stored respectively at offsets 0 and 1 at address X+1; and instruction unit A3 corresponding to the third encoded instruction 526 is stored at address X+1 and at offset 2. Thus for each encoded program instruction 522, 524, 526 there is an associated memory address and each N-bit instruction unit has an offset value that gives a starting location of the program instruction within the memory address. In this case, the instruction unit width is equal to the memory bank width so the offset specifies the memory bank in which the instruction unit is stored.

The FIFO instruction register 230 (see FIG. 2) sequentially reads out each of the three encoded program instructions 522, 524, 526 from the program memory 220. The FIFO instruction register 230 has four N-bit fields that directly correspond to the four memory banks of the program memory 220. Accordingly, each encoded instruction as stored in the FIFO instruction register at stage 528 has four N-bit memory access words. For each encoded instruction, a given instruction unit is read directly from its memory bank in program memory to the corresponding register field of the FIFO instruction register at stage 528. At each cycle, four instruction units are read, starting from the position indicated by the program counter. When the instruction is less than four units long, some of these units are discarded (i.e. not used). In FIGS. 5A and 5B discarded units are represented by dashes.

Thus, for example, the second encoded program instruction 524, has: A2 stored at address X and offset 3; instruction unit B2 stored at address X+1 offset 0; and instruction unit C2 stored at address X+1 and offset 3 in the program memory 220. This second encoded instruction is read into the FIFO instruction register 230 such that instruction unit A2 occupies register offset 3, register offset 2 contains bits that will be discarded, instruction unit C2 occupies register offset 1 and instruction unit B2 occupies register offset 0. For the third encoded program instruction 526, A3 which was stored at address X+1 and offset 2 in the program memory is read into the FIFO instruction register such that it occupies register offset 2. The fields corresponding to register offsets 0, 1 and 3 contain bits that will be discarded. The instruction-units A1, B1 and C1 of the first encoded instruction occupy register offsets 0, 1 and 2 respectively of the FIFO instruction register 230 whilst register offset 3 contains bits that will be discarded.

At stage 550 of FIG. 5A, each of the three encoded program instructions 522, 524, 526 have been aligned (by the program instruction aligner 240 of FIG. 2) in accordance with a predetermined decoder input alignment. In this arrangement, it is required that the encoded instruction is aligned such that the least significant bit of the instruction is at bit position 0 of the decoder input, which is a “little endian” alignment. In an alternative arrangement a “big endian” alignment is used, in which the most significant bit is located at bit position 0 of the-decoder input. Comparing the instruction unit orderings at stage 528 with the predetermined decoder input instruction alignment at stage 550, it can be seen that no rotation is required to align the first encoded instruction 522. However, each instruction unit of the second encoded instruction must be shifted by (i.e. rotated over) one instruction unit (where in this case a word comprises N-bits) and the single instruction unit A3 of the third encoded instruction must be right-shifted by two instruction units.

FIG. 5B schematically illustrates a decoding flow in an arrangement having a program instruction aligner according to the present technique. Stages 510, 520 and 530 in FIG. 5B are identical to the same stages in the decoding flow of FIG. 5A described above. The decoding flow in FIG. 5B differs from the decoding flow of FIG. 5A in that the compiler of FIG. 5B includes an additional stage 545 of program instruction reformatting, which occurs after the encoded program instructions have been packed into memory at stage 527 and prior to reading the encoded program instructions 522, 524, 526 out to the FIFO instruction register 230 at stage 530.

Note that in the arrangement according to FIG. 5B (in which a reordering is performed by the compiler), packing of the instruction words in memory is done in two steps:

1. Determining the positions that will be occupied by the instruction.

2. Storing the instruction in those positions (as shown at stage 527 in FIG. 5B).

The first step should be executed before reordering is performed, because reordering needs to know the offset. However, the second step (stage 527) can be skipped. Thus in an alternative arrangement, the compiler merges the packing stage 527 and reordering stage 545 into one step. These two steps have been illustrated separately in FIG. 5B for the purposes of clearly outlining that re-ordering process, but it will be appreciated that combining the packing and re-ordering into a single step is likely to give rise to a more efficient implementation of a compiler according to the present technique.

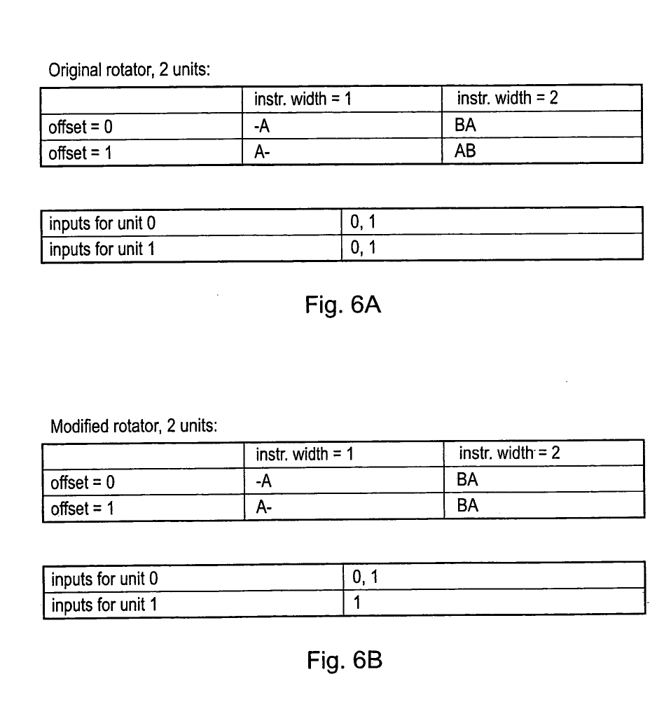

The program instruction reformatting stage, shown in the FIG. 5B as pre-order, rearranges the instruction units of a program instruction within the storage region associated with that program instruction in the memory banks of the program memory such that overall, the range of permutations of instruction units in the program instructions on output from the compiler for a given group of instructions (e.g. for all possible offset values and all possible instruction widths for a given instruction aligner width see FIGS. 6B, 7B and 9B described below) is restricted so as to reduce the complexity of the program instruction aligner that will be used to obtain the predetermined decoder-input alignment. In the particular example of FIG. 5B, where possible, the instruction units are aligned in accordance with the predetermined decoder input alignment. Thus A1, B1, C1, A2 and B2 are all in their final desired decoder-input positions and only C2 and A3 need be shifted. However, the instruction units need not always be re-ordered such that they are output by the compiler in accordance with their final positions in the predetermined decoder input alignment since further shifts can be performed by a program instruction aligner prior to decoding.

Before input to the decoder in this arrangement they are read out to the FIFO instruction register 230 at stage 528. To produce an instruction unit ordering that corresponds to the predetermined decoder input instruction alignment, the least significant unit A1 (where i=1, 2 or 3) of the instruction should be stored in memory bank 0, the next most significant unit B1 in memory bank 1, the next-again most significant instruction unit in memory bank 2 and the most significant instruction unit in memory bank 3. Thus, the program instruction reformatter arranges the instructions by reordering (or swapping) the locations of instruction units within the originally allocated storage region associated with the program instruction to place as many instruction units as possible in positions corresponding to their respective positions in the predetermined decoder input instruction alignment. This reduces the number of movement operations (i.e. shifts) that need to be performed by the program instruction aligner later.

Note that where the originally allocated storage region does not include an N-bit word in the appropriate memory bank to position a given instruction unit according to its position in the predetermined decoder input instruction alignment then the appropriate alignment can only be performed later, by the program instruction aligner when reading the reformatted instruction from the instruction register at stage 530 to the shifter fields at stage 552. In FIG. 5B, this is the case for instruction unit C2 of the second encoded instruction, since the originally allocated storage region in program memory at stage 527 does not include any N-bit word in memory bank 2.

In the arrangement shown in FIG. 5B instruction 1 is already aligned and does not need to be reformatted. Instruction 2 however, is stored in 3 different memory banks, memory bank 3, 0 and 1. The instruction has a width of three units and thus, will be supplied as input to the decoder in positions aligned with memory banks 0, 1 and 2. Thus, in this case the instruction units stored in memory banks 0 and 1 can be reformatted to store appropriate instruction units that align with the decoder inputs while the unit stored in memory bank 3 will never be aligned. Accordingly, in this case the instruction is reformatted such that A2 is stored in memory bank 0 and B2 in memory bank 1, C2 is therefore stored in memory bank 3. Thus, A2 and B2 are aligned with the decoder inputs and do not need to be shifted by the program instruction aligner before input to the decoder.

The third encoded instruction 526 in FIG. 5B comprises a single instruction unit, but since the memory locations allocated to a given program instruction are fixed, there are no degrees of freedom to enable reformatting of the third program instruction 526 in this case. Instruction unit A3 is shifted from a position corresponding to memory bank 2 to a position corresponding to memory bank 0 on reading from the instruction register at stage 530 to the shifter fields at stage 552, prior to input to the decoder.

FIG. 6A is a table listing positions of N-bit instruction units A and B as they are input to fields of the program instruction aligner 240 (i.e. as output by the compiler and as stored in the instruction register 230), for a program instruction aligner having a width equal to two instruction units and for a compiler that writes the instructions to the program memory 220 according to a standard ordering. Note that the ordering on input to the program instruction aligner corresponds to the ordering in the FIFO instruction register 230. In this arrangement the field width of each shifter (i.e. rotator) field is equal to the width of the program instruction unit. The offset specifies the position of the least significant instruction unit A. The bottom portion of the table specifies the required multiplexer inputs to the rotator. The number of inputs depends upon the possible positions of each instruction unit A, B as arranged in the FIFO instruction register 230 for the available range of instruction widths. Thus, the “inputs for unit 0” correspond to possible initial positions of instruction unit A on input to the program instruction aligner for both instruction width=1 and instruction width=2. Similarly, the “inputs for unit 1” correspond to possible initial positions of instruction unit B on input to the program instruction aligner. It can be seen that in this simple case both A and B can be in either of the two positions on input to the program instruction aligner.

FIG. 6B is a table corresponding to the table of FIG. 6A but for a program instruction aligner 240 operable to receive program instructions that have been reordered by the program instruction reformatter of the compiler according to the present technique. For an instruction width=1, there is no freedom to re-order the instructions within the allocated space in program memory so in this case the program instruction aligner input ordering is identical in FIG. 6A and FIG. 6B. However, for an instruction width=2, the program instruction is reordered by the compiler such that an instruction that has an offset=1 is provided to the program instruction aligner such that A is in offset 0 and B is in offset 1. Since B occupies offset 1 on input to the program instruction aligner for both instruction width=1 and instruction width=2, the inputs for unit 1 are reduced relative to the program instruction aligner of FIG. 6A.

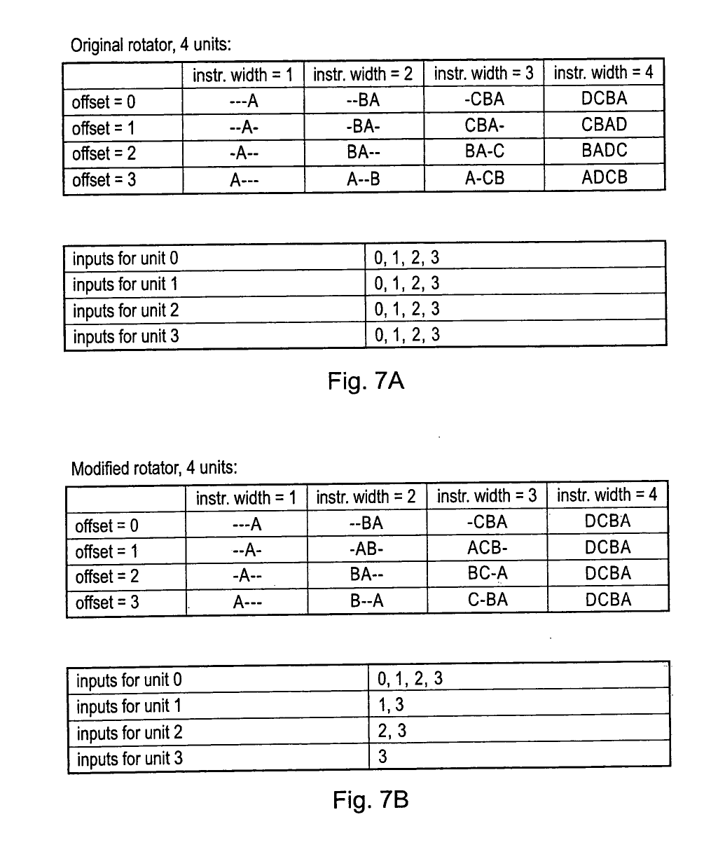

FIG. 7A is a table for a program instruction aligner having a width of four instruction units operable to receive instructions from the compiler according to the standard ordering. In this case the instruction unit positions on input to the program instruction aligner are shown for instruction widths of 1, 2, 3 and 4 units. FIG. 7B is the corresponding table for a “modified program instruction aligner” operable to receive program instructions that have been reordered by a compiler according to the present technique. In FIG. 7A, each instruction unit (A, B, C, D) can occupy any one of the four offsets. Thus each of the four program instruction aligner units must have inputs allowing values to be read from any one of the four offset positions.

In the table of FIG. 7B, although the inputs for unit 0, (corresponding to the input positions of instruction unit A) include all four offset positions, the inputs for unit 1 (corresponding to position of B) consist of offsets 1 and 3 only. Now consider why this is the case in view of the reordered program instructions. In the table of FIG. 7B, for an instruction width=2, it can be seen that there are two alignments in which B is at offset 1 (−BA and −ABA) and two alignments in which B is at offset 3 (BA− and B−A). For an instruction width=3, there are three alignments in which B is 30 at offset 3 (−CBA, ACB− and C−BA) and one alignment in which B is at offset 1 (C−BA). For an instruction width=4, B is at offset 3 for all four alignments. Thus for the full range of instruction widths for this rotator size the only possible positions of B for instructions stored in the FIFO instruction register 230 correspond to either offset 1 or offset 3. Thus the only required multiplexer inputs are 1 and 3 for unit 2. Similarly, referring to the orderings for instruction width=3 and instruction width=4, the inputs for unit 2 (corresponding to position of C) consist of offsets 2 and 3 only. The inputs for unit 3 (corresponding to position of D) consist of offset 3 only, since D is only read into the program instruction aligner from the instruction register 230 such that it is at offset 3.

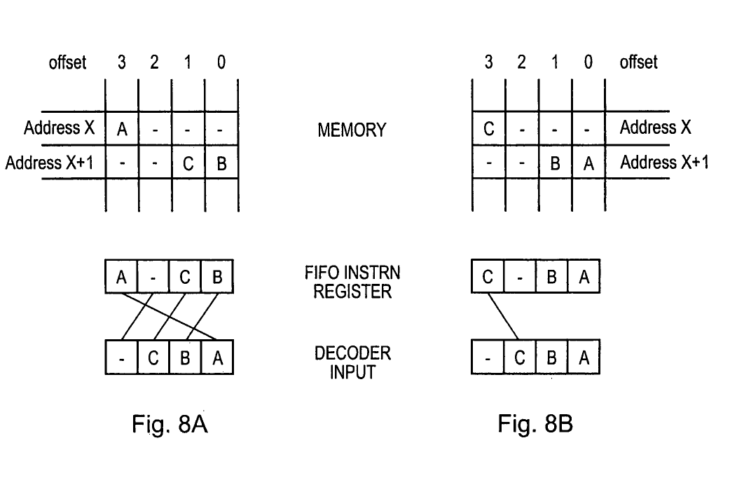

FIGS. 8A schematically illustrates the instruction unit ordering at three different stages of the decoding sequence for a compiler that causes program instructions to memory according to a standard ordering. FIG. 8B shows the corresponding decoding stages for a compiler that performs reordering of the program instructions according to the present technique. This particular example corresponds to the example in the tables of FIGS. 6A and 6B of program instruction aligner width=3, instruction width=3 and offset=3.

In FIG. 8A, the instruction is packed in memory 220 such that it has an offset of 3 at address X. Thus the instruction occupies: offset 3 at address x (instruction unit A); offset 0 at address x+1 (instruction unit B); and offset 1 at address x+1 (instruction unit C). The instruction is read into the instruction register 230 as shown and input to the program instruction aligner 240 such that B is at offset 0, C is at offset 1 and A is at offset 3. The program instruction aligner 240 then right-shifts. each instruction unit by 3 to obtain an appropriate decoder-input alignment.

In FIG. 8B, the compiler reorders the program instruction from the standard ordering shown in FIG. 8A to an ordering in which: A occupies offset 0 at address x+1; B occupies offset 1 at address x+1; and C occupies offset 3 at address x. Instruction units A, B and C, which were originally mapped respectively to: address x and offset 3; address x+1 and offset 0; address x+1 and offset 1. Thus it can be seen that the same memory locations have been used, but the instruction has been re-ordered within those memory locations i.e. unit C occupies the memory location formerly occupied by A; A occupies the memory location formerly occupied by B; and B occupies the memory location formerly occupied by C. The required decoder input ordering is such that A is at offset 0, B is at offset 1 and C is at offset 3. Thus the program instruction aligner of FIG. 8A must right-shift each of the instruction units by 3 positions whereas the program instruction aligner of FIG. 8B need only shift a single one of the instruction units, C, to the right by one position. A, and B are already appropriately aligned on input to the program instruction aligner so that these units need not be shifted.

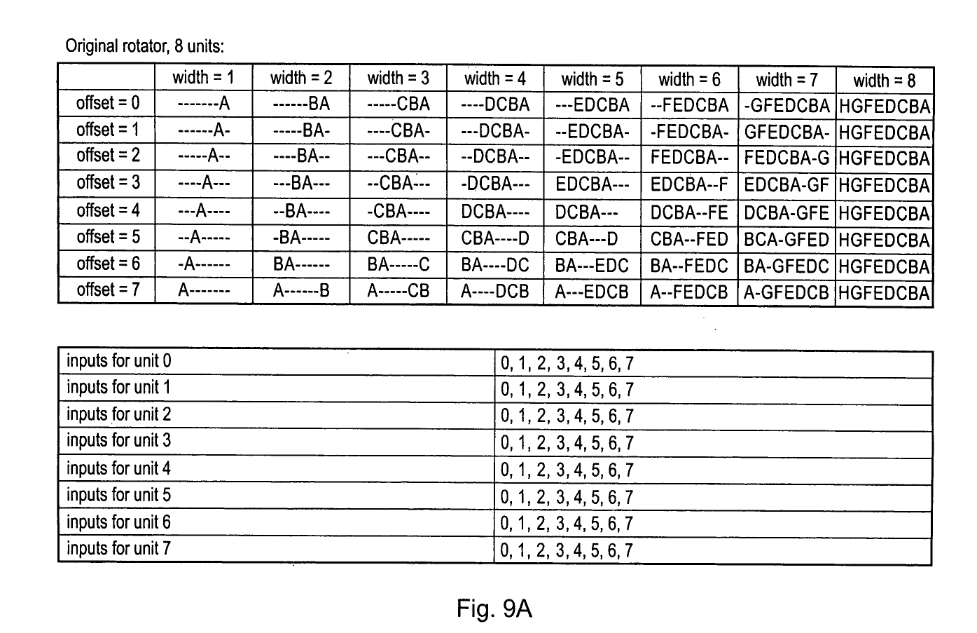

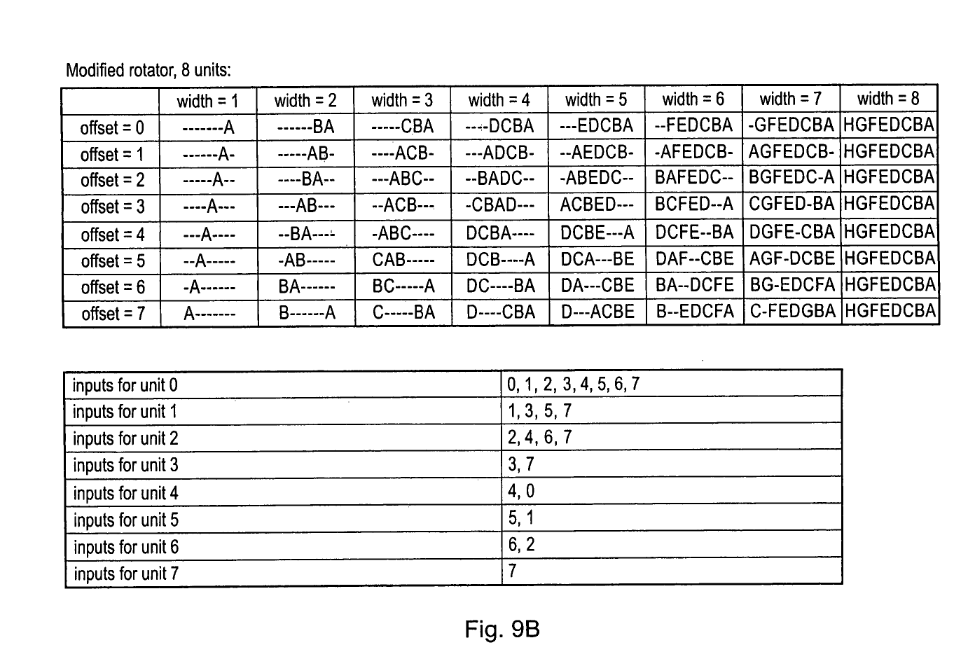

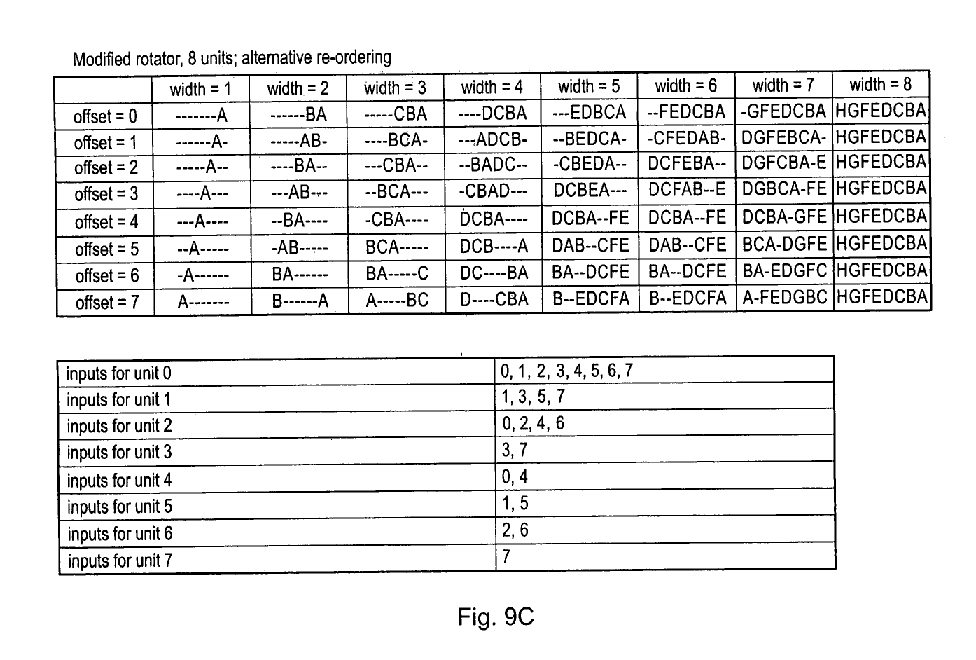

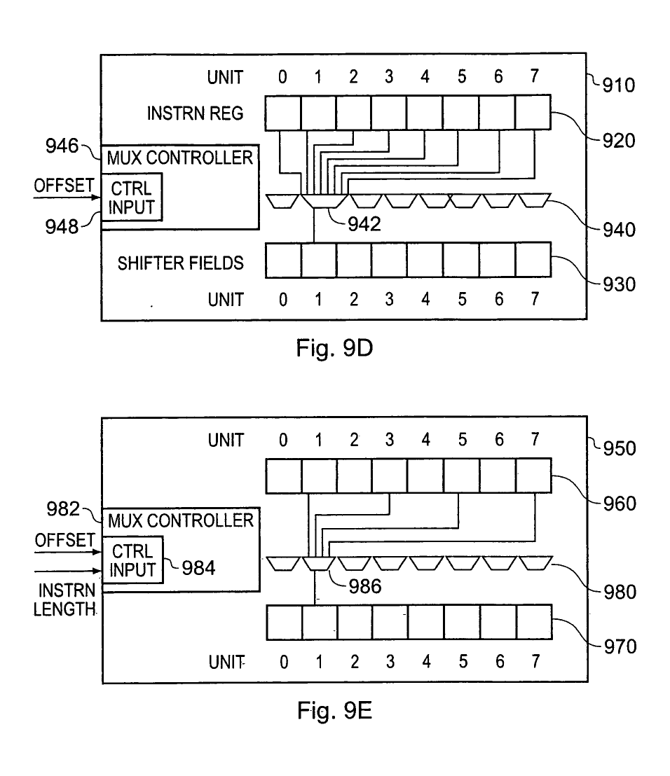

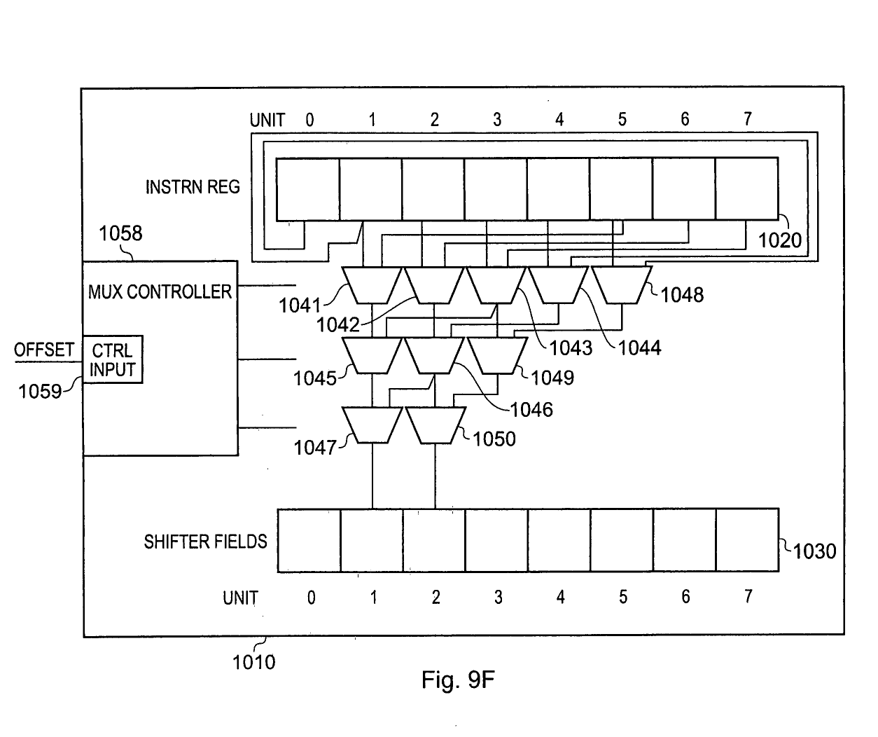

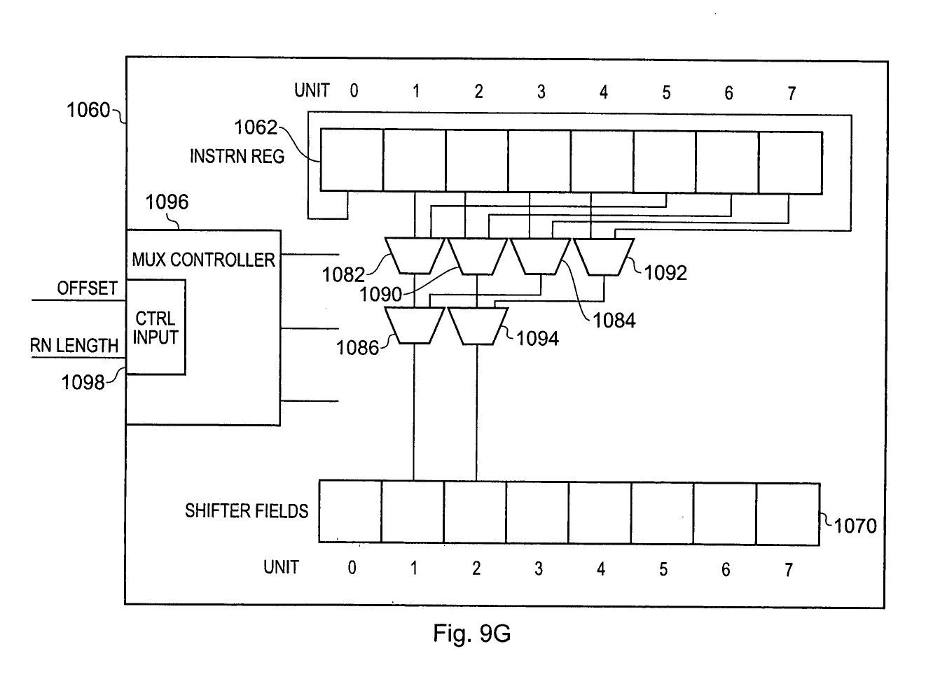

FIG. 9A is a table for a program instruction aligner having a width of eight instruction units and operable to receive instructions from the compiler according to a standard. FIG. 9B is the corresponding table for a “modified program instruction aligner” operable to receive program instructions that have been reordered by a compiler according to the present technique. In this case the instruction unit positions on input to the program instruction aligner are shown for instruction widths of 1, 2, 3, 4, 5, 6, 7 and 8 units. Similarly to the case for the tables of FIGS. 6A and 7A, the full range of eight multiplexer inputs is required for each of the eight units of the instruction for input to the decoder. However, for the re-ordered program instructions of FIG. 8B, a considerably reduced set of multiplexer inputs is required for all but unit 0 of the decoder input (corresponding to instruction unit A). In particular, the inputs for unit 1 (instruction unit B) are 1,3,5 and 7; the inputs for unit 2 (instruction unit C) are 2, 4, 6 and 7; the inputs for unit 3 (instruction unit D) are 3 and 7; the inputs for unit 4 (instruction unit E) are 4 and 7; the inputs for unit 5 (instruction unit F) are 5 and 7; the inputs for unit 6 (instruction unit G) are 6 and 7; and the input for unit 7 (instruction unit H) is 7 only.

See, for example the column relating to instruction width=7 in the tables of FIG. 9A and FIG. 9B respectively. For offset=0 no reordering is performed since the original instruction ordering coincides with the required decoder input alignment. For offset=3, for example, according to the original ordering, not a single one of the program units is at a position corresponding to the correct decoder input alignment whereas for the re-ordered program instruction shown in FIG. 9B program units A, B, D, E, F and G are each situated at positions corresponding to their correct decoder input alignment, so that only program unit C need be shifted by the program instruction aligner before the instruction is input to the decoder. Note that in some cases, for example for an instruction width=3; offset=5 a reordering is performed that does not result in any of the program units being at an appropriately aligned position for decoding. It is not possible to align any of the program units in this case because only offsets 5, 6 and 7 can be used for reordering whereas the required decoder alignment uses offsets 0, 1, 2. However, in this case the re-ordering is performed such that overall the number of multiplexer inputs is reduced. In general, the reordered positions of the instruction units that cannot be aligned according to the required decoder input are arranged such that the total number of alternative positions for a given instruction unit in the entire group of program instruction for a given shifter (rotator) size (i.e. for the full range of offsets and instruction lengths listed in the table of FIG. 8B) is reduced. In this particular example, it can be seen that if the original ordering CBA−, were preserved, then B would occupy offset 6, which would mean that the inputs for unit 1 (corresponding to B) would have to include 6 in addition to 1, 3, 5 and 7. Accordingly, the instruction is re-ordered such that it is input to the program instruction aligner as CAB−.

Note that the instruction unit ordering produced by the modified program instruction aligner as listed in Table 9B is such that the shifter is operable to produce the predetermined decoder-input instruction alignment by shifting in a single direction between one end of the plurality of shifter fields and an opposite end of the plurality of shifter fields. For example in the table of FIG. 9A, for instruction width=4 and for offset=6 instruction units C and D must each be shifted to the left by two positions whereas instruction units A and B must each be right-shifted by five positions. By way of contrast, for instruction width=4 and offset=6 in the modified program instruction aligner of Table 9B, only right-shifts of instruction units C and D are required and no left-shifts. Similarly, both left-shifts and right-shifts are required for instruction width=4 offset=5, 7 in FIG. 9A whereas only right-shifts are required for the corresponding parameters in FIG. 9B.

The single-direction-shift, described in the above paragraph, is no longer valid in the corrected table for FIG. 8B. It probably is only possible for instructions up to 4 units wide.

FIG. 9C schematically illustrates a program unit alignment for a program instruction aligner width of eight program units in which the compiler reorders the program instructions, but does so according to an alternative ordering to that of FIG. 8B. Thus, the set of multiplexer inputs for FIG. 9C differ from those of FIG. 9B. It can be seen, for example, that in Table 9C for instruction width=7 and offset=7 on input to the program instruction aligner the instruction unit ordering is A-FEDGBC so that units B, D, E and F are in appropriately aligned positions for input to the decoder. By way of contrast, for the same parameters the instruction unit ordering in FIG. 9B is F-EDCBA, so that only unit F must be shifted prior to decoding. However, the arrangement of FIG. 9C still aligns more program units in their appropriate positions that the originally ordered program instructions of FIG. 8A and allows for fewer multiplexer inputs than FIG. 9A.

The reordering performed by the compiler is suitably arranged such that it reduces the complexity of the aligner. It will be appreciated that reordering instruction units into their final position is one way to do this. This is done for instruction units B, D, E and F (for width=7 and offset=7) in the case of FIG. 9C discussed above. However, in attempting to reduce the complexity of the manipulations to be performed to achieve the required decoder input alignment, it is likely to be impractical to allow for all instruction units to retain their final desired positions. For example in FIG. 9C, for width=6 and offset=1, the word C could have been placed in unit 2, the position that is required at the input of the decoder. However, instead, unit 2 is used to store A. However, overall, the complexity of the shifter required to align the program instructions output by the compiler to achieve the predetermined decoder input instruction alignment is reduced since the number of multiplexer inputs for units 1 though 7 (see FIG. 9C) is reduced relative to the corresponding number of inputs shown in the case of the instructions of FIG. 9A, which have not been reordered by the compiler. Thus it can be seen that the effect of reordering is to reduce the complexity of the manipulations that must be performed on instructions output by the compiler in order to achieve the required decoder input instruction alignment. -This is illustrated by comparison of FIG. 9C and FIG. 9D below. The reduction in complexity can amount to a reduced number of shifts for a given program instruction unit or an overall reduction in the number of possible permutations required to move an instruction word output by the compiler to its desired- decoder input instruction alignment, which in turn reduces the required number of multiplexer inputs associated with that instruction word.

FIG. 9D schematically illustrates a program instruction aligner corresponding to the tables of FIG. 9A (i.e. an aligner that aligns compiled program instructions that have not been re-ordered). The instruction aligner 910 of FIG. 9D comprises: an instruction register 920; a plurality of shifter fields 930; an array of multiplexers 940; and a multiplexer controller 946 having a control input 948. In this arrangement the shifter is implemented as a full cross-bar shifter. In a full cross-bar shifter, for each output unit (i.e. for each unit of the shifter fields 930), there is an associated multiplexer with the required inputs. In FIG. 9D the inputs of a single multiplexer 942 of the multiplexer array 940 are shown for clarity. As listed in the lower table of FIG. 9A, the inputs for unit 1 comprise instruction register units 0, 1, 2, 3, 4, 5, 6, 7 and it follows that the multiplexer 942 has eight inputs corresponding respectively to the eight fields of the instruction register 920. Each of the eight multiplexers in the aligner of FIG. 9D actually requires eight inputs similarly to multiplexer 942. This arrangement represents a full cross-bar shifter. The array of multiplexers 940 is controlled by the multiplexer controller 946 in dependence upon an offset value supplied to the multiplexer controller 946 via the control input 948.

FIG. 9E schematically illustrates a program instruction aligner according to the present technique and corresponding to the tables of FIG. 9A and FIG. 9B. Similarly to the arrangement of FIG. 9D, this program instruction aligner comprises an instruction register 960, a plurality of shifter fields 970 and an array of multiplexers 980. The arrangement further comprises a multiplexer controller 982 having a control input 984 operable to receive an offset value and an instruction length. A shifter formed by the multiplexer array 980 and the plurality of shifter fields 970 is operable to shift at least a portion of the reformatted program instruction stored in the instruction register 960 to produce the predetermined decoder-input instruction alignment. The shifting is performed in dependence upon the offset value and the program instruction length. The connections of a multiplexer 986 of the multiplexer array 980 are shown in detail. The multiplexer 986 provides inputs to the shifter unit 1. From the tables of FIGS. 9B and 9C, it can be seen that the inputs required to unit 1 are 1, 3, 5 and 7 only. Shifts of words A, B, C, D, E, F, G, H from inputs 0, 2, 4 and 6 are not required due to the strategic re-ordering of the program instructions performed by the compiler. Similar simplifications to the inputs to the multiplexers associated with shifter fields 2 to 7 are achieved via instruction re-ordering. Thus it can be seen that the manipulations to be performed by the program instruction aligners associated respectively with FIG. 9B and FIG. 9C are less complex -than the manipulations that must be provided for in the full cross-bar shifter of FIG. 9D (associated with the tables of FIG. 9A). The program instruction aligner of FIG. 9E can be considered to be a full cross-bar shifter but with at least one input removed, thereby reducing the complexity of the aligner.

Although the arrangement of FIG. 9E shows an aligner having a multiplexer associated with each output unit (i.e. each shifter field), the present technique is not limited to such an arrangement.

Each of the multiplexers in FIG. 9D can be replaced by a tree of two-input multiplexers. This is illustrated in FIG. 9F. The arrangement of FIG. 9F comprises a program instruction aligner 1010 having a plurality of instruction register fields 1020; a plurality of shifter fields 1030; a tree of multiplexers supplying unit 1 of the shifter fields 1041, 1042, 1043, 1044, 1045, 1046 and 1047; additional multiplexers required to supply signals to unit 2 of the shifter fields 1048, 1049 and 1050; a multiplexer controller 1058 and an associated control input 1059. The multiplexer controller 1058 receives an offset value via the control input 1059 and the multiplexers are controlled in dependence upon this offset.

The multiplexer for the output to unit 1 of the shifter fields 1030 is replaced by a multiplexer tree with three layers containing respectively 4, 2 and 1 two-input multiplexers. The first layer comprises multiplexers 1041, 1042, 1043 and 1044. The second layer comprises multiplexers 1045 and 1046. The third layer comprises the multiplexer 1047. The multiplexer for output to unit 2 of the shifter fields 930 in FIG. 9D has also been replaced in the arrangement of FIG. 9F. It requires a similar tree to that of the shifter unit 1, but most of the multiplexers can be shared with the tree 1041, 1042, 1043, 1044, 1045, 1046, 1047 for unit. Only one two-input multiplexer in each of the three layers must be added. In particular, in the first layer, multiplexer 1048 is added; in the second layer multiplexer 1049 is added and in the third layer multiplexer 1050 is added. The other two-input multiplexers can-be shared because they use the same inputs and when their output is selected in the tree for unit 1, it is not selected in the tree for unit 2, and visa versa. When all of the 8 multiplexers 940 in FIG. 9D are replaced this way, the result contains three layers of eight two-input multiplexers. This structure is known as a logarithmic barrel shifter.

The multiplexer array 980 from FIG. 9E, which is an aligner operable to align re-ordered program instructions, can be replaced by trees of two-input multiplexers in a similar way. Because the multiplexers of FIG. 9E have less inputs than the corresponding multiplexers of FIG. 9D (which deals with program instructions that have not been re-ordered) do, these trees are smaller. FIG. 9F shows this change for the multiplexer 1086 that drives the output for unit 1. Because the corresponding multiplexer 986 in FIG. 9E has only 4 inputs, the tree requires only three two-input multiplexers 1082, 1084 and 1086.

FIG. 9G schematically illustrates a modified logarithmic shifter implementation of a program instruction aligner arranged to align the reordered program instructions of the tables of FIG. 9.

The arrangement comprises a program instruction aligner 1060 having a plurality of instruction register fields 1062; a plurality of shifter fields 1070; a first tree of multiplexers 1082, 1084, 1086 associated with unit 1 of the shifter fields 1070; a second tree of multiplexers 1090, 1092, 1094 associated with unit 2 of the shifter fields; and a multiplexer controller 1096 and associated control input 1098. The multiplexer controller 1096 controls the multiplexers in dependence on control inputs comprising an offset value and an instruction length value.

The multiplexer for unit 2 of the shifter fields 970 of FIG. 9E has also been replaced in FIG. 9G. This comprises the multiplexers 1090, 1092 and 1094. Since it also has four inputs, it also needs three two-input multiplexers. However, unlike the situation in FIG. 9F, none of these multiplexers are shared. They cannot be shared because they do not have the same inputs.

When all multiplexers are implemented this way, some two-input multiplexers use the same inputs. But most of them cannot be shared because they are used in different trees at the same time. Still the total number of two-input multiplexers in the arrangement of FIG. 9G is less than for the logarithmic barrel shifter of FIG. 9F. Thus it will be appreciated that even in the logarithmic shifter type arrangements of FIGS. 9F and 9G, re-ordering of the program instructions still gives rise to a simplification of the aligner circuitry.

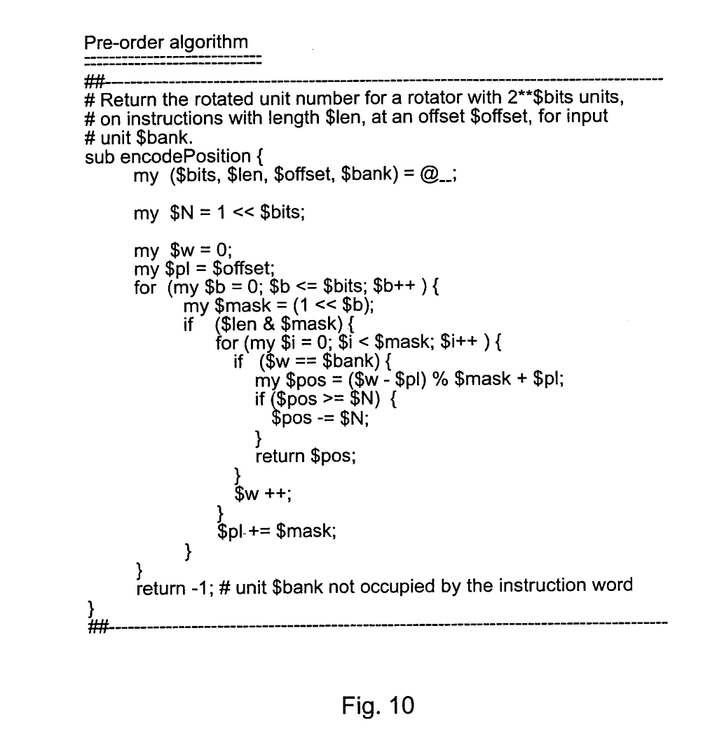

FIG. 10 is program code used to generate the instruction re-ordering of FIG. 9C.

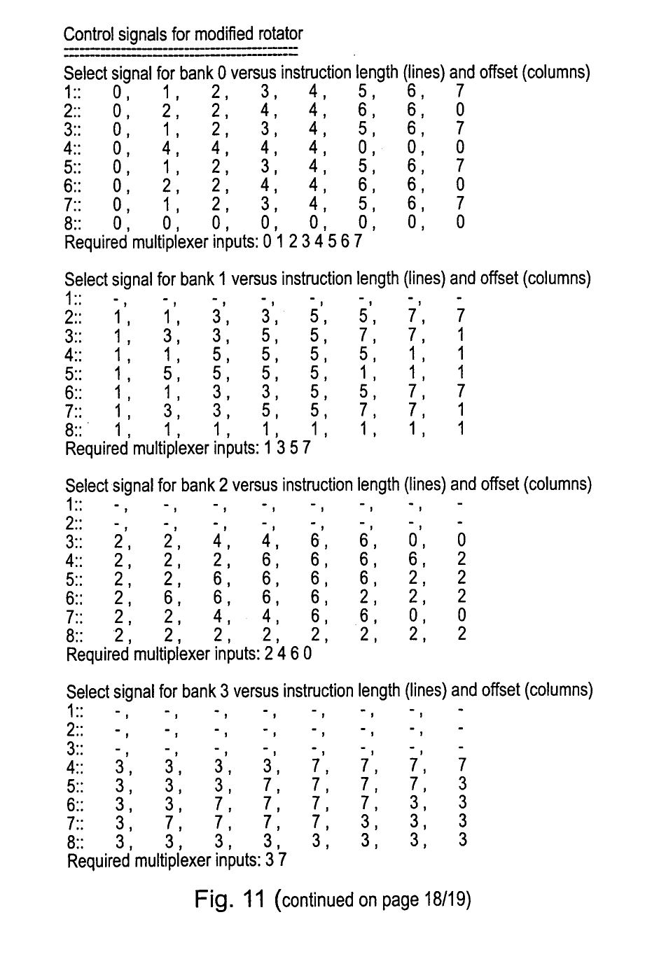

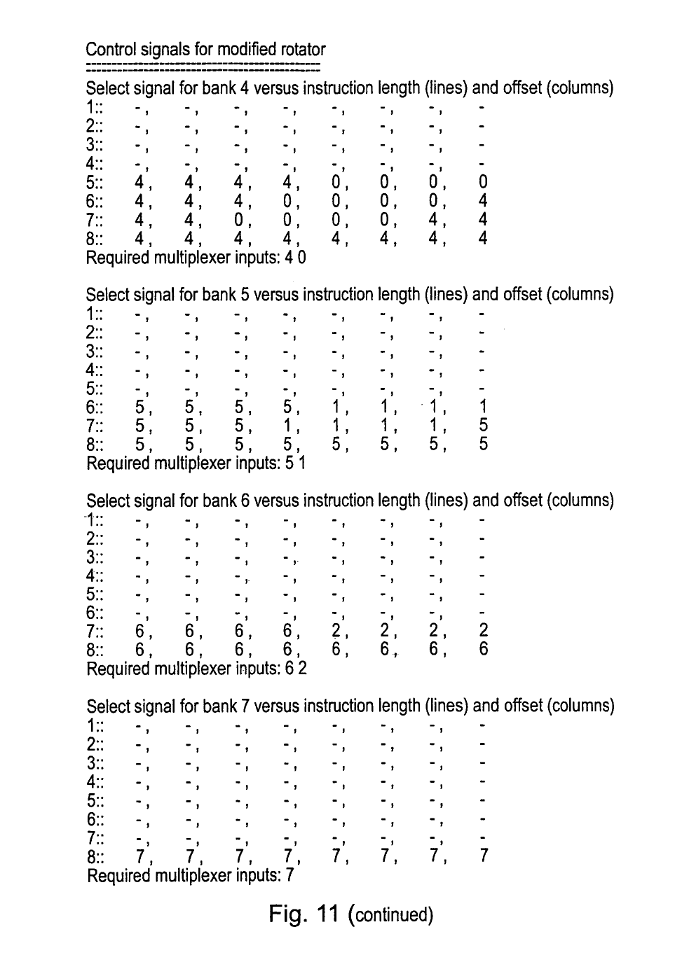

FIG. 11 is a series of tables showing the select signals and multiplexer inputs required for the program instruction aligner configured to receive program instructions that have been re-ordered as listed in FIG. 9C.

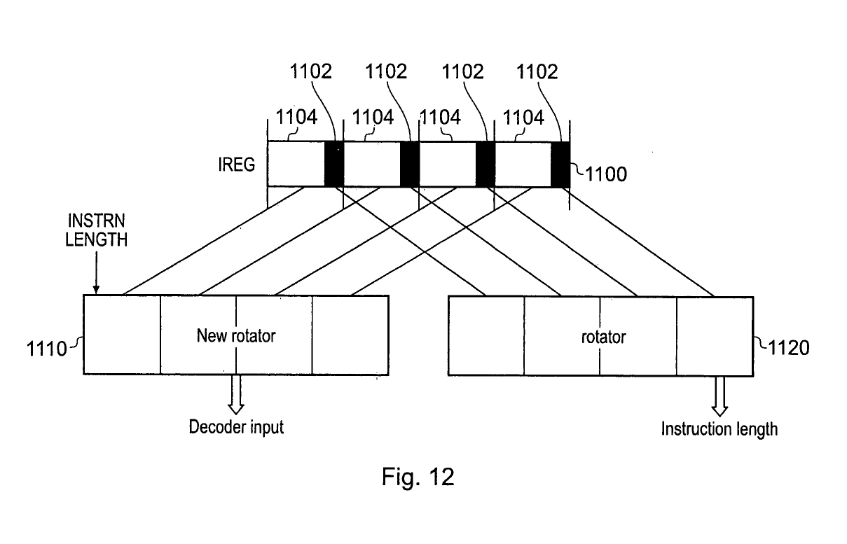

FIG. 12 schematically illustrates a program instruction aligner arrangement comprising a combination of two different program instruction aligners and is operable to align program instructions for input to a decoder. The arrangement comprises a program instruction register 1100, a first program instruction aligner 1110 and a second program instruction aligner 1120.

The instruction register 1100 is four units wide and holds four program instruction units, each of which comprises an instruction field portion 1104 and an instruction set ID portion 1102. The first program instruction aligner 1110 is arranged to receive only the instruction field portions 1102 of the four program instruction units and the second program instruction aligner 1120 is arranged to receive only the instruction set ID portions 1104 of the program instructions. In this particular example, the instruction set ID bits 1102 comprise the four least significant bits of each program instruction unit. The second program instruction aligner 1120 is used to obtain an instruction length, which is encoded in the instruction set identifier 1102 portions. The instruction length is required by the first program instruction aligner 1110 as a control input together with an instruction offset in order to determine the instruction unit shifts to be performed in order to appropriately align the program instruction for input to the decoder.

In the arrangement illustrated in FIG. 12, the instruction set ID bits comprise the four least significant bits of each program instruction unit of the program instruction. A single bit (i.e. length flag bit) in the instruction set identifier portion 1102 of each program instruction unit is used to encode the length. In this case, the flag bit of the last unit of a given instruction is set to “1” and is set to “0” in all units that are not the last unit in an instruction. This arrangement has the advantage that there is less delay to obtain the instruction length from such an encoding. For instructions that are N program units long a total of N bits of the instruction set identifier 1102 portions are dedicated to encoding the instruction length. It will be appreciated that this is just one of a number of alternative possible formats for variable length program instructions according to the present technique. For example, the instruction set ID portion could be contained within a single one of the program instruction units as in the example of FIG. 3A, rather than being distributed- across a plurality of program instruction units of a variable length instruction.

The shifter according to the present technique (as illustrated, for example, in FIG. 9E), uses both the offset and the length to determine what it has to do to align the reordered program instruction in accordance with the predetermined decoder-input alignment. The length is encoded in the instruction in the instruction set ID portion 1102 (see FIG. 12 description).

In alternative arrangements, instead of explicitly encoding the length in the instruction, the position of each unit of the instruction is encoded. This encoding can be relative to the address and offset of the first unit of the instruction, or it can be relative to the address only of that unit.

For example, if there are eight memory banks, the instruction can contain eight bits, one bit per memory bank. A ‘1’ in such a bit indicates that the bank contains a unit of the current instruction, whereas a ‘0’ indicates that this bank does not contain a unit for this instruction. The length of the instruction can be derived from the number of ‘1’ bits. Such an arrangement may be convenient in order to facilitate alignment of some instructions on specific boundaries and/or to avoid stalls.

In further alternative arrangements the instruction length that is required as a control input to the program instruction aligner according to the present technique can be determined at an earlier stage, before the program instructions are input to the FIFO instruction register 230 (see FIG. 2).

In order to determine the instruction length in advance in this way branch prediction can be used. Thus, for example, it is assumed that the next instruction to be executed, is probably the instruction that follows the current instruction in memory. Therefore, the hardware starts to extract the length from that instruction, before it is certain that this will indeed be the next instruction to execute. When a branch is taken, this advance-determined length is not used. Instead the correct instruction is fetched, and an extra cycle is used to determine the length. This means that for at least one cycle, no instruction decoding will be possible. The processor is stalled during this cycle.

In the arrangements described above, the units of the program instruction aligner 240 are -equal to the widths of the memory banks 222, 224, 226, 228 of the instruction memory 220. However, in alternative arrangements the program instruction-aligner units may differ in size (wider or narrower) from the width of the memory banks. The smallest size of a program instruction aligner unit is a single bit.

In the examples of FIGS. 6B, 7B and 9B, the program instruction aligner width is equal to the width of the widest instruction. In alternative arrangements the program instruction aligner width could be greater than the width of the widest instruction. For example, the FIFO instruction register 230 can be buffered such that it can hold two program instruction words and the width of the program instruction aligner can be doubled correspondingly such that it has the capacity to store two program instruction words.

In further alternative arrangements the units on which the program instruction aligner operates can be of variable size. Clearly, in this case the multiplexer inputs will be more complex.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

I claim:

1. A compiler for compiling program instructions in dependence upon a predetermined decoder input instruction alignment, said compiler comprising:
a program instruction sequence generator operable to process source code to produce a sequence comprising a plurality of program instructions for input to a decoder, at least one of said plurality of program instructions having an instruction length of at least two instruction units and wherein said at least one program instruction has a respective storage region within said program memory, said storage region having an associated memory address and an offset value, said offset value giving a starting location of said program instruction within said memory address; and
a program instruction reformatter operable to reorder said at least two instruction units of said at least one program instruction within said storage region to generate a reordered program instruction, said reordering being such that manipulations of instruction units of said plurality of program instructions required to achieve said predetermined decoder input instruction alignment are less complex than manipulations that would be required if no reordering had been performed.

2. A compiler according to claim 1, wherein said reordering of said at least two instruction units of said at least one program instruction is such that at least one of said instruction units is in a position corresponding to its respective position in said predetermined decoder input instruction alignment.

3. A compiler according to claim 1, wherein said program memory comprises at least two memory banks and each of said at least two instruction units is stored in a respective one of said at least two memory banks.

4. A compiler according to claim 3, wherein each of said at least two memory banks has an associated memory bank data width and wherein a data width of each of said at least two instruction units is equal to said memory bank data width.

5. A compiler according to claim 1, wherein said instruction unit ordering of said reformatted instruction by said program instruction reformatter is such that each instruction unit of said reformatted program instruction that can be placed in a position corresponding to its predetermined position in said predetermined decoder input alignment given said storage region is placed in said predetermined position.

6. Compiler according to claim 5, wherein if an instruction unit of said reformatted program instruction cannot be placed in said predetermined position given said memory space, said program instruction reformatter is operable to place said instruction unit in a position that reduces a total number of alternative positions of that instruction unit in a plurality of reformatted program instructions.

7. Compiler according to any claim 1, wherein said program instruction reformatter is operable to reformat a plurality of program instructions to produce a respective plurality of reformatted program instructions.

8. Compiler according to claim 7, wherein said plurality of program instructions comprises program instructions having variable instruction lengths.

9. Compiler according to claim 1, wherein said predetermined decoder-input instruction alignment is one of a big-endian alignment and a little-endian alignment.

10. A program instruction aligner operable to read said reformatted program instruction from a program memory and to shift at least one portion of said reformatted program instruction generated by a compiler according to claim 1 in order to align said reformatted program instruction in accordance with a predetermined decoder-input instruction alignment for input to an instruction decoder, said program instruction aligner comprising:
an instruction register having a plurality of register fields, said instruction register being operable to store said reformatted program instruction;
a control input operable to receive said instruction length and said offset value associated with said reformatted program instruction; and
a shifter having:
a plurality of shifter fields, a number of said plurality of shifter fields being operable to receive said at least two instruction units of said reformatted program instruction from said plurality of register fields; and
an array of multiplexers operable to provide a plurality of connections between at least some of said plurality of register fields and at least some of said plurality of shifter fields;
wherein said shifter is operable to shift in dependence upon said instruction length and said offset value, at least a portion of said reformatted program instruction to produce said predetermined decoder-input instruction alignment and wherein said plurality of connections is such that at least one of said plurality of register fields is connected to only a subset of said plurality of shifter fields, said reformatted instruction having an instruction unit ordering such that no connections from said at least one register field to ones of said plurality of shifter fields outside said subset are required to produce said predetermined decoder-input instruction alignment.

11. Program instruction aligner according to claim 10, wherein said shifter is operable to shift each of a plurality of reformatted program instructions corresponding to a respective plurality of instruction unit orderings and wherein said subset is dependent upon said plurality of instruction unit orderings.

12. Program instruction aligner according to claim 10, wherein said plurality of instruction unit orderings is such that said shifter is operable to produce said predetermined decoder-input instruction alignment by shifting in a single direction between one end of said plurality of shifter fields and an opposite end of said plurality of shifter fields.

13. Program instruction aligner according to claim 10, wherein said instruction unit ordering of said reformatted program instruction is such that at least one of said instruction units is in a position corresponding to its respective position in said predetermined decoder-input instruction alignment.

14. Program instruction aligner according to claim 10, wherein said instruction unit ordering of said reformatted instruction is such that each instruction unit of said reformatted program instruction that can be placed in a position corresponding to its predetermined position in said predetermined decoder input alignment is placed in said predetermined position.

15. Program instruction aligner according to claim 11, wherein said plurality of instruction unit orderings are restricted such that said subset is a minimal subset that enables said predetermined decoder-input alignment to be obtained for each of said plurality of reformatted program instructions.

16. Program instruction aligner according to claim 15, wherein if a given instruction unit of said reformatted program instruction cannot be placed in said predetermined position, it is placed in a position that reduces a total number of alternative positions of said given instruction unit in said plurality of reformatted program instructions thereby reducing said subset.

17. Program instruction aligner according to any claim 10, wherein a data width of at least one of said plurality of shifter fields is equal to a data width of a corresponding one of said plurality of register fields.

18. Program instruction aligner according to claim 10, wherein said plurality of shifter fields are equal in number to said plurality of register fields.

19. Program instruction aligner according to claim 10, wherein said reformatted program instruction comprises an instruction-length specifying portion and wherein said instruction length specifying portion is used to derive said instruction length for supplying to said control input.

20. Program instruction aligner according to claim 19, comprising an instruction length extraction register operable to store a copy of said reformatted program instruction and to extract said instruction length from said instructions length specifying portion to supply to said control input.

21. Program instruction aligner according to claim 19, wherein said length-specifying portion corresponds to a flag bit in each of said at least two instruction units.

22. Program instruction aligner according to claim 19, wherein said shifter is operable to receive a portion of said reformatted program instruction that excludes said instruction-length specifying portion.

23. Program instruction aligner according to claim 10, wherein said shifter is implemented as a full cross-bar shifter having at least one input removed.

24. Program instruction aligner according to claim 10, wherein said shifter is implemented as a logarithmic shifter comprising a plurality of two-input multiplexers and having at least one fewer two-input multiplexer than a standard logarithmic shifter.

25. Program instruction aligner according to claim 24, wherein said shifter comprises at least one duplicated multiplexer relative to said standard logarithmic shifter.

26. Program instruction aligner according to claim 10, wherein said predetermined decoder-input instruction alignment is one of a big-endian alignment and a little-endian alignment.

27. A method of compiling program instructions in dependence upon a predetermined decoder input instruction alignment, said method comprising the steps of:
processing source code to produce a sequence comprising a plurality of program instructions for input to a decoder, at least one of said plurality of program instructions having an instruction length of at least two instruction units and wherein said at least one program instruction has a respective storage region within said program memory, said storage region having an associated memory address and an offset value, said offset value giving a starting location of said program instruction within said memory address; and
reordering said at least two instruction units of said at least one program instruction within said storage region to generate a reordered program instruction, said reordering being such that a number of manipulations of instruction units of said plurality of program instructions required to achieve said predetermined decoder input instruction alignment is reduced relative to a number of manipulations that would be required if no reordering had been performed.

28. A computer program product holding a computer readable medium including computer readable instructions that when executed perform the steps of a method according to claim 27.
